(19) United States
(12) Patent Application Publication
(10) Pub. No.: US 2021/0016399 A1
(43) Pub. Date: Jan. 21, 2021

(54) JIG FOR HOLDING PEDAL ASSEMBLY IN VEHICLE

(71) Applicant: Honda Motor Co., Ltd., Tokyo (JP)

(72) Inventors: BENJAMIN B. MACARTHUR, BARRIE (CA); RACHEL ANNE EMERY, ANGUS (CA)

(21) Appl. No.: 16/511,830

(22) Filed: Jul. 15, 2019

(51) Int. Cl. B23P 19/04; B62D 65/02; B62D 65/10

(52) U.S. Cl. CPC B23P 19/04; B62D 65/10; B62D 65/026

(57) ABSTRACT

A jig for holding a pedal assembly in a vehicle. The jig includes a pedal pad receiving portion configured to receive the pedal assembly. The jig further includes a pin receiving portion configured to receive a pin to releasably secure the jig with a pedal arm of the pedal assembly. The pedal pad receiving portion is configured to hold the pedal assembly of the vehicle in an upward position during a manufacturing process. The jig further includes at least one grip portion located on a bottom surface of the jig. The at least one grip portion secures the jig with a floor of the vehicle.

### BACKGROUND

Various techniques are being developed to support parts of a vehicle during manufacturing or repair operations. One of the examples of such parts of the vehicle is a pedal assembly. The pedal assembly may be associated with a reservoir for a fluid which that may be controlled based on the movement of the pedal assembly. During different manufacturing or repair operations, the pedal assembly has to be set at an upward position, for the successful filing or re-filling of the fluid in the reservoir. In certain situations (for example due to vibration or movement of the vehicle during the manufacturing or repair operations), the filing of the fluid in the reservoir fails due to undesired movement of the pedal assembly.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

In accordance with one embodiment of the disclosure, a jig is provided for holding a pedal assembly in a vehicle. The jig may include a pedal pad receiving portion that may be configured to receive the pedal assembly. The jig may further include a pin receiving portion that may be configured to receive a pin to releasably secure the jig with a pedal arm of the pedal assembly. The pedal pad receiving portion may be configured to hold the pedal assembly of the vehicle in an upward position during a manufacturing process. The jig may further include at least one grip portion located on a bottom surface of the jig. The at least one grip portion may be configured to secure the jig with a floor of the vehicle.

In accordance with another embodiment of the disclosure, a jig is provided for holding a pedal assembly in a vehicle. The jig may include a pedal pad receiving portion that may be configured to receive the pedal assembly. The jig may further include a pin receiving portion that may be configured to receive a pin to releasably secure the jig to a pedal arm of the pedal assembly. The pedal pad receiving portion may be configured to hold the pedal assembly of the vehicle and may prevent disengagement of the pedal assembly from the jig during a manufacturing process. The jig may further include at least one grip portion that may be located on a bottom surface of the jig. The at least one grip portion may be configured to secure the jig with a floor of the vehicle.

In yet another embodiment of the disclosure, a method may be provided for assembling a jig. The method may include securing at least one grip portion of the jig with a floor of the vehicle. The at least one grip portion may be located at a bottom surface of the jig. The method may further include positioning a pedal assembly of the vehicle in a pedal pad receiving portion of the jig. The method may further include inserting a pin in a pin receiving portion of the jig. The pin receiving portion may be configured to receive the pin to releasably secure the jig with a pedal arm of the pedal assembly. The pedal pad receiving portion may be configured to hold the pedal assembly of the vehicle in an upward position during a manufacturing process.

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

### BRIEF DESCRIPTION OF THE DRAWINGS

FIG. 1 illustrates a perspective front view of a jig coupled with a pedal assembly of a vehicle, in accordance with an embodiment of the disclosure.

FIG. 2 illustrates a perspective bottom view of the jig of FIG. 1, in accordance with an embodiment of the disclosure.

FIG. 3A illustrates a cut-out view of the jig of FIG. 1 coupled with a pedal assembly of a vehicle, in accordance with an embodiment of the disclosure.

FIG. 3B illustrates a rear view of the jig of FIG. 1 coupled with a pedal assembly of a vehicle, in accordance with an embodiment of the disclosure.

FIG. 4 illustrates a perspective view of a first portion and a second portion of the jig of FIG. 1, in accordance with an embodiment of the disclosure.

FIG. 5 is a flowchart that illustrates an exemplary method for assembling the jig of FIG. 1, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed jig for holding a pedal assembly in a vehicle. Exemplary aspects of the disclosure provide the jig for firmly holding a pedal pad of the pedal assembly in an upward position in the vehicle. Examples of the pedal assembly may include, but are not limited to, a clutch pedal assembly, a brake pedal assembly, or an accelerator pedal assembly. The jig may include a pedal pad receiving portion which may be configured to receive the pedal assembly and hold the pedal assembly in an upward position during a manufacturing process. Examples of the manufacturing process may include, but is not limited to, filling of a fluid in a reservoir of the pedal assembly. The disclosed may further include a pin receiving portion which may be configured to receive a pin to releasably lock the jig with the pedal arm of the pedal assembly during the manufacturing process. Thus, the locking of the pedal arm in the upward position within the jig, may prevent disengagement of the pedal assembly from the jig during the manufacturing process (i.e. filing of the fluid).

The disclosed jig further may include at least one grip portion located on a bottom surface of the jig, where the grip portion may be configured to secure the jig with a floor of the vehicle. The grip portion on the bottom surface of the jig may firmly attach the jig with the floor of the vehicle and may prevent the movement of the jig locked with the pedal assembly during the manufacturing process. Thus, the combination of the pin received by the pin receiving portion and the grip portion attached with the floor of the vehicle may ensure successful completion of filing of the fluid in the reservoir associated with the pedal assembly.

Reference will now be made in detail to specific aspects or features, examples of which are illustrated in the accompanying drawings. Wherever possible, corresponding or similar reference numbers will be used throughout the drawings to refer to the same or corresponding parts.

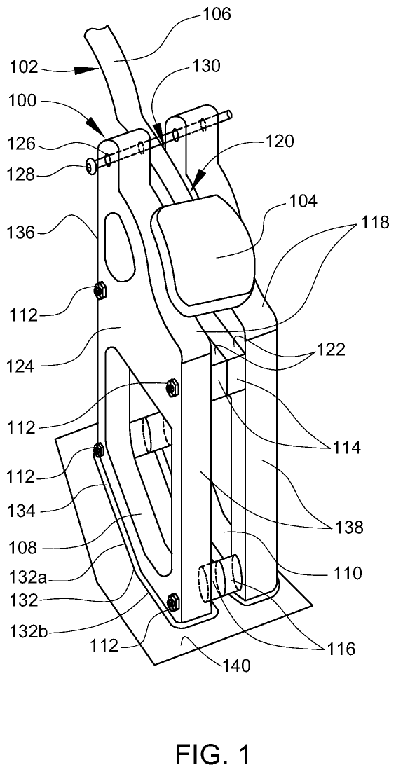

FIG. 1 illustrates a perspective front view of a jig coupled with a pedal assembly of a vehicle, in accordance with an embodiment of the disclosure. With reference to FIG. 1, there is shown a perspective front view of a jig 100 that may be coupled with a pedal assembly 102 of a vehicle (not shown). The pedal assembly 102 may include a pedal pad 104. In one embodiment, the pedal pad 104 may be coupled with a pedal arm 106 of the vehicle with a plurality of fasteners, or through an interference fit. Examples of interference fit may include, but are not limited to, a rubber pad that may couple the pedal pad 104 with the pedal arm 106. In other embodiments, the pedal pad 104 may be coupled with the pedal arm 106 of the vehicle through a metal working process. For example, the metal working process may be a welding process. However, the metal working process may include other processes including, but are not limited to, a casting process, a machining process, and the like.

It should be noted here that the pedal assembly 102 shown in FIG. 1 is merely provided as an example and should not be construed as limiting for the disclosure. The present disclosure may be applicable to any pedal assembly which may include, but is not limited to, a clutch pedal assembly, a brake pedal assembly, an accelerator pedal assembly or the like. Further, the pedal assembly 102 may also include other components, which have been omitted from the present disclosure for the sake of brevity. Modifications and/or additions (e.g., in terms of design and arrangement) may be made to the pedal assembly 102 of the vehicle, without departing from the scope of the present disclosure.

Further referring to FIG. 1, the jig 100 may be configured to hold the pedal pad 104 in an upward position during the manufacturing process which may include filling of a fluid in a fluid reservoir. As shown in FIG. 1, the jig 100 may include a two-portion structure that may include a first portion 108 and a second portion 110. In some embodiments, the first portion 108 may have a similar shape or size as the second portion 110. The similar shape of the first portion 108 and the second portion 110 may provide ease in the mass manufacturing of the jig 100. The first portion 108 and the second portion 110 may be coupled to each other through one or more fasteners 112 to form the jig 100. For example, the one or more fasteners 112 may be at least one or more set screws. In some embodiments, the one or more fasteners 112 may include, but are not limited to, one or more rivets, one or more bolt and nuts, or one or more screws, and the like.

With reference to FIG. 1, each of the first portion 108 and the second portion 110 may further include a first fastener guide 114 and a second fastener guide 116. The first fastener guide 114 and the second fastener guide 116 may guide the one or more fasteners 112 during assembly of the first portion 108 and the second portion 110 to form the jig 100. The width of the first fastener guide 114 and the second fastener guide 116 may be directly proportional to the width of the jig 100. The width of the first fastener guide 114 and the second fastener guide 116 may be changed in accordance with size of pedal assembly 102. In some embodiments, the first fastener guide 114 of each of the first portion 108 and the second portion 110 may have a rectangular structure. In another embodiment, the first fastener guide 114 may have other structures, for example, but not limited to, a cylindrical structure, a square structure, and the like. In some embodiments, the second fastener guide 116 may have various structures, for example (but not limited to), a cylindrical structure, a square structure, a rectangular structure, and the like.

The jig 100 may further include a first surface 118 in each of the first portion 108 and the second portion 110. A pedal pad receiving portion 120 may be formed in the jig 100 between the first surface 118 of each of the first portion 108 and the second portion 110. The pedal pad receiving portion 120 may be formed in the jig 100 when the first portion 108 and the second portion 110 are coupled with each other through the one or more fasteners 112. The pedal pad receiving portion 120 may be formed on a first surface 122 of the first fastener guide 114. The pedal pad receiving portion 120 may be configured to hold the pedal arm 106 of the pedal assembly 102. The pedal pad receiving portion 120 may be configured to hold the pedal assembly 102 or the pedal pad 104 in the upward position during the manufacturing process.

The jig 100 may further include a second surface 124 that may extend orthogonally with respect to the first surface 118 of each of the first portion 108 and the second portion 110. The second surface 124 of each of the first portion 108 and the second portion 110 of the jig 100 may include a pin receiving portion 126, which may be configured to receive a pin 128 to releasably lock or secure the jig 100 with the pedal arm 106 (or the pedal pad 104) of the pedal assembly 102. The pin receiving portion 126 may be configured to receive the pin 128 (say from a user or mechanic) and lock the pedal arm 106 in the jig 100 during a manufacturing process or after an incomplete fluid fill. In some embodiments, the pin 128 may be one of a push locking pin or a detent pin for releasably securing the jig 100 with the pedal arm 106 of the pedal assembly 102. In other embodiments, the pin 128 may have other structures, but not limited to, an eye pin, a cotter pin, and the like.

In some embodiments, the insertion of the pin 128 in the pin receiving portion 126 may form a locking portion 130 in the pedal pad receiving portion 120. The locking portion 130 may lock the pedal arm 106 of the pedal assembly 102 or eventually engage the pedal pad 104 in-place with the jig 100, and may further prevent the movement of the pedal pad 104 from the jig 100 during the manufacturing process, i.e. filing of the fluid in the fluid reservoir. Thus, the prevention of the movement or disengagement of the pedal assembly 102 from the jig 100 may ensure successful completion of filing of the fluid in the fluid reservoir. The pedal pad receiving portion 120 and the inserted pin 128 may hold the pedal assembly 102 in the upward position as shown in FIG. 1, to ensure the successful completion of filing of the fluid in the fluid reservoir during a locking state of the pedal pad 104 with the jig 100. Further, upon completion of the manufacturing process or the filling of the fluid in the fluid reservoir of the pedal assembly 102, the user or the mechanic may release the pin 128 from the pin receiving portion 126 of the jig 100 to release the pedal arm 106 from the jig 100 for other manufacturing or normal processes of the vehicle.

As shown in FIG. 1, the jig 100 may include a bottom surface 132 (i.e. third surface). The jig may further include a fourth surface 136 (i.e. rear surface) and a fifth surface 138 that may extend orthogonally to the first surface 118, the second surface 124, and the bottom surface 132 of each of the first portion 108 and the second portion 110. The fourth surface 136 and the fifth surface 138 may be oppositely located, and positioned parallel to each other, such that, the first surface 118, the second surface 124, and the bottom surface 132 may orthogonally extend between the fourth surface 136 and the fifth surface 138 of each of the first portion 108 and the second portion 110 of the jig 100.

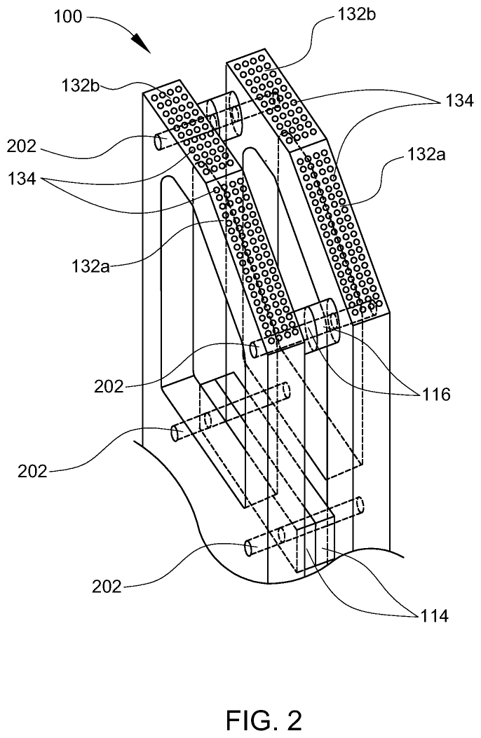

FIG. 2 illustrates a perspective bottom view of the jig of FIG. 1, in accordance with an embodiment of the disclosure. FIG. 2 is explained in conjunction with elements from FIG. 1. With respect to FIG. 1 and FIG. 2, the jig 100 may include the bottom surface 132 (shown in FIG. 1) that may extend orthogonally to the second surface 124 of each of the first portion 108 and the second portion 110. The bottom surface 132 may be located substantially parallel to the first surface 118 of each of the first portion 108 and the second portion 110. In another embodiment, the bottom surface 132 may include a sloped surface 132a and a flat surface 132b that may extend between the fourth surface 136 and the fifth surface 138 of each of the first portion 108 and the second portion 110.

As shown in FIG. 2, one or both of the sloped surface 132a and the flat surface 132b of each of the first portion 108 and the second portion 110 may include at least one grip portion 134. The at least one grip portion 134 may be configured to attach or secure the jig 100 with a floor 140 of the vehicle as shown in FIG. 1. In an embodiment, the grip portion 134 may include one of a grip tape, a suction cup, a hatched surface, or a textured surface to attach or secure the jig 100 with the floor 140 of the vehicle. As shown in FIG. 2, the jig 100 may include a plurality of grip portions (for example grip tape, suction cup, hatched surface, or textured surface). Since, the grip portion 134 secures the jig 100 with the floor 140 of the vehicle, the jig 100 may not fall-out or move during the manufacturing process or during the filling of the fluid in the fluid reservoir. Thus, the grip formed (by the at least one grip portion 134) between the jig 100 and the floor 140 of the vehicle may also ensure successful completion of the filing of the fluid in the fluid reservoir by preventing movement of the pedal assembly 102 and hold the pedal assembly 102 in the upward position. Further, the grip formed (i.e. by the at least one grip portion 134) between the jig 100 and the floor 140 of the vehicle may also control the movement or vibrations of the jig 100 when engaged with the pedal assembly 102.

In an embodiment, the sloped surface 132a of the bottom surface 132 may correspond with contours of the floor 140 of the vehicle. The sloped surface 132a may include the at least one grip portion 134, so that, the at least one grip portion 134 (attached to the sloped surface 132a of the jig 100) may effectively grip the contours of the floor 140 of the vehicle so that the jig 100 may not fall-out or move during the filling of the fluid in the fluid reservoir. In other embodiments, the flat surface 132b may correspond with the contours of the floor 140 of the vehicle. The flat surface 132b may also include the at least one grip portion 134, such that the at least one grip portion 134 attached to the flat surface 132b of the jig 100 may effectively grip the contours of the floor 140 of the vehicle and prevent the fall-out or movement of the jig 100 during the manufacturing process or during the filling of the fluid in the fluid reservoir of the pedal assembly 102.

In a preferred embodiment, the bottom surface 132 may include at least one of the sloped surface 132a or the flat surface 132b to correspond with the contours of the floor 140 of the vehicle. In some embodiment, one of the sloped surface 132a or the flat surface 132b may include the at least one grip portion 134, so that, the at least one grip portion 134 may firmly grip against the contours of the floor 140 of the vehicle.

It should be noted here that positions, shapes and/or numbers of the at least one grip portion 134 shown in FIG. 2 is merely provided as an example and should not be construed as limiting for the disclosure. The present disclosure may be applicable to any shape, position on the bottom surface 132, and/or numbers of the grip portion 134, which have been omitted from the present disclosure for the sake of brevity. Modifications and/or additions (e.g., in terms of design, arrangement, position, and shapes) may be made to the at least one grip portion 134, without departing from the scope of the present disclosure.

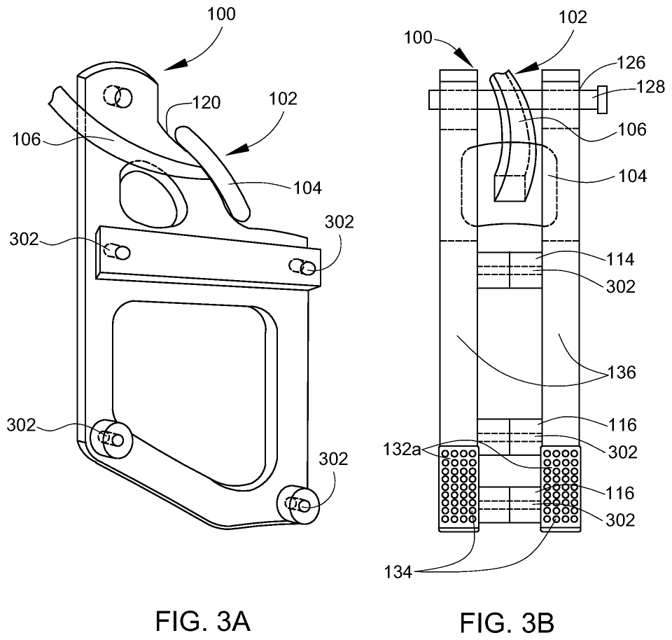

FIG. 3A illustrates a cut-out view of the jig of FIG. 1 coupled with a pedal assembly of a vehicle, in accordance with an embodiment of the disclosure. FIG. 3A is explained in conjunction with elements from FIG. 1 and FIG. 2. With reference to FIGS. 1, 2, and 3A, each of the first fastener guide 114 and the second fastener guide 116 (shown in FIGS. 1-2) of each of the first portion 108 and the second portion 110 of the jig 100 may include at least one threaded portion 302. The threaded portion 302 may be configured to receive a bolt (not shown) to fasten the first portion 108 with the second portion 110 to form the jig 100.

In other embodiments, each of the first fastener guide 114 and the second fastener guide 116 may include at least one insert 202 (as shown in FIG. 2) that may be configured receive the bolt to fasten the first portion 108 with the second portion 110 of the jig 100. In another embodiment, each of the first fastener guide 114 and the second fastener guide 116 of the first portion 108 may include at least one threaded portion 302, and each of the first fastener guide 114 and the second fastener guide 116 of the second portion 110 may include at least one bolt. The threaded portion 302 of the first portion 108 may be configured to receive the bolt of the second portion 110 to fasten the first portion 108 with the second portion 110 to form the jig 100.

In an embodiment, the pedal pad receiving portion 120 may have an arc shape (as shown in FIG. 3A) which may match with contours of the shape of the pedal pad 104, so that the pedal pad 104 may firmly grip the contours of the arc shape of the pedal pad receiving portion 120. Since, the arc shape of the pedal pad receiving portion 120 may be firmly griped with the contours of the pedal pad 104, the pedal pad 104 may not fall-out or disengage from the jig 100 during the manufacturing process (i.e. filling of the fluid in the fluid reservoir) or due to movement of the jig 100 or the vehicle. The arc shape of the pedal pad receiving portion 120 shown in FIG. 3A is merely an example. In some embodiments, the pedal pad receiving portion 120 may have other shapes, but not limited to, a C-shape, or a flat shape, and the like.

FIG. 3B illustrates a rear view of the jig of FIG. 1 coupled with a pedal assembly of a vehicle, in accordance with an embodiment of the disclosure. FIG. 3B is explained in conjunction with elements from FIG. 1, FIG. 2 and FIG. 3A. As shown in FIG. 3B, the pedal assembly 102 or the pedal pad 104 may be locked with the jig 100 based on the inserted pin 128 in the pin receiving portion 126 of the jig 100. In the rear view of the jig 100, there is further shown the fourth surface 136 (as also shown in FIG. 1). The rear view of the jig 100 may further indicate the at least one grip portion 134 located on the sloped surface 132a of the bottom surface 132.

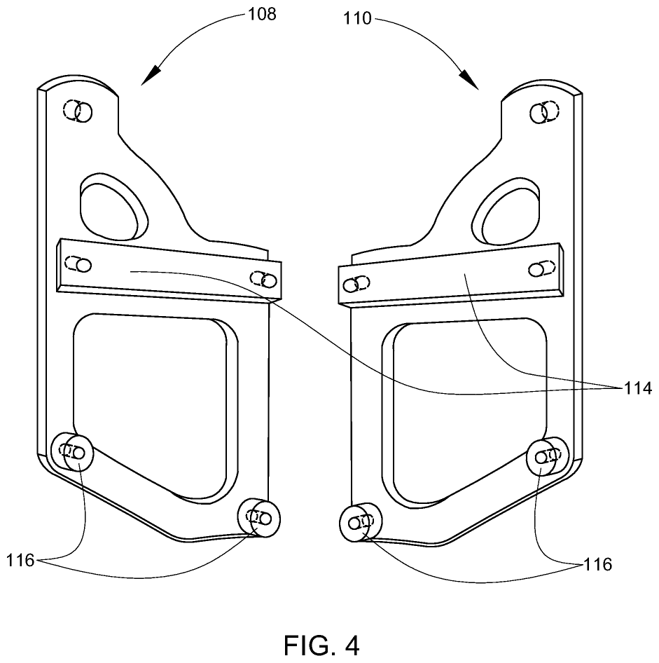

FIG. 4 illustrates a perspective view of a first portion 108 and a second portion 110 of the jig as shown in FIG. 1, in accordance with an embodiment of the disclosure. FIG. 4 is explained in conjunction with elements from FIG. 1, FIG. 2, FIG. 3A, and FIG. 3B. In FIG. 4, there is shown the first portion 108 and the second portion 110 of the jig 100 as described in FIG. 1. During the manufacturing or mass production of the jig 100, each of the first portion 108 and the second portion 110 may be formed (for example based on molding process). The first portion 108 and the second portion 110 may be attached with each other using the one or more fasteners 112 to form the jig 100 as described, for example, in FIG. 1.

In some embodiments, the jig 100 may be a single-piece structure (not shown). The pedal pad receiving portion 120 may be located at the first surface 118 of the single-piece structure of the jig 100. The pedal pad receiving portion 120 may be configured to receive the pedal pad 104 of the pedal assembly 102 in the upward position during the manufacturing process. The pin receiving portion 126 may be located on the second surface 124 of the single-piece structure of the jig 100, wherein the pin receiving portion 126 may be configured to receive the pin 128 to releasably lock the jig 100 with the pedal pad 104. The bottom surface 132 of the single-piece structure of the jig 100 may be configured to attach or secure the jig 100 with the floor 140 of the vehicle through the attached grip portions 134 to firmly grip the contours of the floor 140 of the vehicle and further prevent movement of the jig 100 during the filling of the fluid in the fluid reservoir of the pedal assembly 102 or during other manufacturing process.

In some embodiment, the jig 100 may be made of a light-weight material, so that, the user or mechanic may handle the jig 100 easily during an assembling process of the jig 100 with the pedal assembly 102 or during other manufacturing processes. In some embodiment, the light-weight material may be a nylon material. Other examples of the light-weight material may include, but are not limited to at least one of a plastic material, a carbon fiber material, a metal material, or a Kevlar® material.

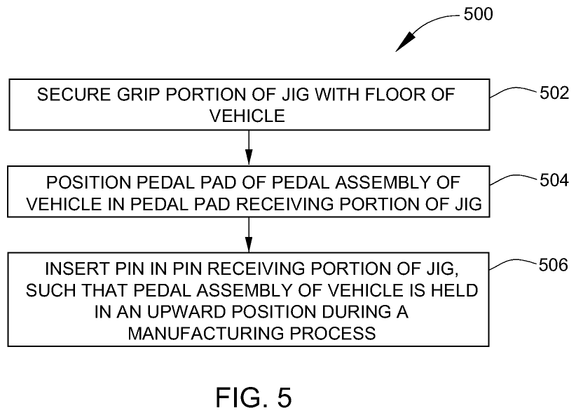

FIG. 5 is a flowchart that illustrates an exemplary method for assembling the jig of FIG. 1, in accordance with an embodiment of the disclosure. FIG. 5 is explained in conjunction with elements from FIGS. 1, 2, 3A, 3B, and 4. With reference to FIG. 5, there is shown a flowchart 500 that depicts a method for assembling the jig 100 in a vehicle. The method illustrated in the flowchart 500 may start from 502.

At 502, the grip portion 134 of the jig 100 may be secured with the floor 140 of the vehicle. The grip portion 134 may be located at the bottom surface 132 of the jig 100 as described in detail, for example, in FIG. 2.

At 504, the pedal pad 104 of the pedal assembly 102 of the vehicle may be positioned in the pedal pad receiving portion 120. The pedal pad receiving portion 120 may be located between the first surface 118 of each of the first portion 108 and the second portion 110 in the two-portion structure of the jig 100 as shown in FIG. 1.

At 506, the pin 128 may be inserted in the pin receiving portion 126 of the jig 100 such that the pedal assembly 102 of the vehicle may be held in the upward position during the manufacturing process and the movement or the disengaging of the pedal assembly 102 from the jig 100 may be prevented.

The flowchart 500 is illustrated as discrete operations, such as 502, 504, and 506. However, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments.

1. A jig for holding a pedal assembly in a vehicle, the jig comprising:
a pedal pad receiving portion configured to receive the pedal assembly;
a pin receiving portion configured to receive a pin to releasably secure the jig with a pedal arm of the pedal assembly,
wherein the pedal pad receiving portion is configured to hold the pedal assembly of the vehicle in an upward position during a manufacturing process; and
at least one grip portion located on a bottom surface of the jig, wherein the at least one grip portion is configured to secure the jig with a floor of the vehicle.

2. The jig according to claim 1, wherein the pedal assembly comprises at least one of a clutch pedal assembly, a brake pedal assembly, or an accelerator pedal assembly.

3. The jig according to claim 1, wherein the pin comprises at least one of a push locking pin or a detent pin for releasably securing the jig with the pedal arm of the pedal assembly.

4. The jig according to claim 1, wherein the manufacturing process includes a process for filling a fluid in a reservoir.

5. The jig according to claim 1, wherein the pedal pad receiving portion corresponds with contours of the shape of a pedal pad located in the pedal assembly.

6. The jig according to claim 1, wherein the pin receiving portion is configured to receive the pin and lock the pedal arm in the jig during an incomplete fluid fill process of the manufacturing process.

7. The jig according to claim 6, wherein the pin receiving portion is configured to release the pin to release the pedal arm from the jig after completion of the fluid fill process of the manufacturing process.

8. The jig according to claim 1, wherein the jig has a two-portion structure that comprises a first portion and a second portion, wherein the first portion is coupled with a second portion to form the jig.

9. The jig according to claim 8, wherein the first portion and the second portion includes at least one threaded portion, and wherein the at least one threaded portion is configured to receive a bolt to couple the first portion with the second portion.

10. The jig according to claim 8, wherein the first portion includes at least one threaded portion and the second portion includes a bolt, and wherein the at least one threaded portion is configured to receive the bolt to couple the first portion with the second portion.

11. The jig according to claim 1, wherein the at least one grip portion is configured to be attached with the floor of the vehicle to prevent the movement of the jig.

12. The jig according to claim 11, wherein the at least one grip portion comprises at least one of a grip tape, a hatched surface, a textured surface, or a suction cup.

13. The jig according to claim 11, wherein the bottom surface corresponds with contours to the floor of the vehicle.

14. A jig for holding a pedal assembly in a vehicle, the jig comprising:
a pedal pad receiving portion configured to receive the pedal assembly;
a pin receiving portion configured to receive a pin to releasably secure the jig with a pedal arm of the pedal assembly, wherein the pedal pad receiving portion is configured to hold the pedal assembly of the vehicle and prevent disengagement of the pedal assembly from the jig during a manufacturing process; and
at least one grip portion located on a bottom surface of the jig, wherein the grip portion is configured to secure the jig with a floor of the vehicle.

15. The jig according to claim 14, wherein the pedal assembly comprises at least one of a clutch pedal assembly, a brake pedal assembly, or an accelerator pedal assembly.

16. The jig according to claim 14, wherein the pin comprises at least one of a push locking pin or a detent pin for releasably securing the jig with the pedal arm of the pedal assembly.

17. The jig according to claim 14, wherein the manufacturing process includes a process for filling a fluid in a reservoir.

18. The jig according to claim 14, wherein the pedal pad receiving portion corresponds with contours of the shape of a pedal pad located in the pedal assembly

19. The jig according to claim 14, wherein the at least one grip portion comprises at least one of a grip tape, a hatched surface, a textured surface, or a suction cup.

20. A method for assembling a jig in a vehicle, comprising:
securing at least one grip portion of the jig with a floor of the vehicle, wherein the at least one grip portion is located at a bottom surface of the jig;
positioning a pedal pad of a pedal assembly of the vehicle in a pedal pad receiving portion of the jig; and
inserting a pin in a pin receiving portion of the jig, wherein the pin receiving portion is configured to receive the pin to releasably secure the jig with a pedal arm of the pedal assembly, and wherein the pedal pad receiving portion is configured to hold the pedal assembly of the vehicle in an upward position during a manufacturing process.
